(19) United States
(12) Patent Application Publication
(10) Pub. No.: US 2026/0055028 A1
(43) Pub. Date: Feb. 26, 2026

(54) METHODS FOR THE CONTROL OF SHRINKAGE OF CEMENTITIOUS COMPOSITIONS AND CEMENTITIOUS GROUTS HAVING CONTROLLED SHRINKAGE

(71) Applicant: SIKA TECHNOLOGY AG, Baar (CH)

(72) Inventor: Juan Antonio CALAMA, Salamanca (ES)

(73) Assignee: SIKA TECHNOLOGY AG, Baar (CH)

(21) Appl. No.: 19/104,725

(22) PCT Filed: Sep. 19, 2023
(86) PCT No.: PCT/EP2023/075747

§ 371 Date: Feb. 19, 2025

(30) Foreign Application Priority Data
Sep. 26, 2022 (EP) 22382878.1

(51) Int. Cl. C04B 24/32; C04B 14/06; C04B 18/14; C04B 22/00; C04B 22/04; C04B 22/06; C04B 28/08; C04B 40/00; C04B 103/56; C04B 111/34

(52) U.S. Cl. CPC C04B 24/32; C04B 14/062; C04B 18/146; C04B 22/008; C04B 22/04; C04B 22/064; C04B 28/08; C04B 40/0042; C04B 2103/58; C04B 2111/346; C04B 2201/20

(57) ABSTRACT

A method for the control of the shrinkage of cementitious materials, the method comprising the steps of providing a cementitious material, adding aluminium powder to the cementitious material, adding calcium oxide or magnesium oxide to the cementitious material, and adding a shrinkage reducing agent which is an organic molecule to the cementitious material. Cementitious grouts including aluminium powder, calcium oxide or magnesium oxide, and a shrinkage reducing agent which is an organic molecule.

### TECHNICAL FIELD

The present invention relates to methods for the control of shrinkage of cementitious compositions using a combination of aluminium powder, calcium oxide or magnesium oxide, and a shrinkage reducing agent which is an organic molecule. The present invention also relates to cementitious grouts comprising such combination of aluminium powder, calcium oxide or magnesium oxide, and a shrinkage reducing agent which is an organic molecule.

### BACKGROUND OF THE INVENTION

It is well known that cementitious materials, for example concrete or grouts, shrink during hardening. Known shrinkage mechanisms can be classified as plastic shrinkage, drying shrinkage, autogenous shrinkage, and carbonation shrinkage. Shrinkage frequently is a problem, because it induces internal stress in the hardened cementitious material and, if the stress is higher than the tensile strength of the material, leads to cracking. Also, shrinkage is especially problematic in case of cementitious materials for grouting because grouting materials are commonly intended to completely fill a pre-defined volume.

It is known in the art to use admixtures for cementitious materials that can reduce or compensate the shrinkage. For example, gas-evolving admixtures can be used to compensate shrinkage of cementitious materials. The most frequently used gas-evolving admixture being aluminium powder. However, it has been described in literature, that especially in cases where Portland cement is replaced in cementitious materials by ground granulated blast furnace slag (GGBFS), the effect of aluminium powder can lead to excessive expansion and much reduced strength (J. Kuziak et al “Influence of the Type of Cement on the Action of the Admixture Containing Aluminium Powder” in Materials, 2021, 14, 2927).

The replacement of Portland cement by pozzolanic and/or latent hydraulic materials, such as GGBFS, is however desirable to reduce the CO₂ footprint of cementitious materials and especially of cementitious grouts.

It is known from WO 2016/185264 (Holcim Technology) that a combination of low-reactivity calcium oxide or magnesium oxide and organic shrinkage reducing agent can be used to control shrinkage in a concrete composition based on a binder having 75 w % Portland cement and 25 w % GGBFS.

There is, however, still a need for further and improved admixtures to reduce the shrinkage of cementitious materials, especially where there is a high replacement level of Portland cement by pozzolanic and/or latent hydraulic materials, especially by GGBFS.

### SUMMARY OF THE INVENTION

It is an objective of the present invention to provide methods for the reduction of shrinkage of cementitious materials, especially of cementitious grouts. Very preferably, the present invention provides methods for the reduction shrinkage of cementitious materials where cement, especially Portland cement, is replaced by slag, especially GGBFS. It is also an objective of the present invention to provide cementitious materials for grouting which have reduced shrinkage. Especially, such cementitious grouts have high replacement levels of cement by slag. Cementitious materials, especially grouts, of the present invention are useful in many applications, for example in the construction of wind towers.

The objective of the present invention is solved by a method as claimed in claim 1. It is thus at the core of the present invention to add aluminium powder and calcium oxide or magnesium oxide to a cementitious composition to reduce the shrinkage of said cementitious composition. The present invention makes use of the finding that aluminium powder and calcium oxide or magnesium oxide act synergistically in reducing the shrinkage of cementitious materials, especially where cement is replaced by slag.

Further aspects of the present invention are the subject of independent claims. Preferred embodiments of the present invention are the subject of dependent claims.

### DETAILED WAYS

In a first aspect the present invention relates to a method for the control of the shrinkage of cementitious materials, said method comprising the steps of
(i) providing a cementitious material,
(ii) adding aluminium powder to said cementitious material,
(iii) adding calcium oxide or magnesium oxide to said cementitious material, (iv) adding a shrinkage reducing agent which is an organic molecule to said cementitious material,
wherein the cementitious material has a density of not less than 800 kg/m³, preferably not less than 1800 kg/m³ after hardening.

Cementitious materials within the present context are materials comprising at least one cementitious binder and optionally additionally aggregates, fillers, admixtures, additives, and/or water. Further materials may additionally be present, such as, for example, reinforcing fibers. Cementitious materials of the present invention set and harden when mixed with water.

A cementitious binder within the present context is a binder which reacts with water to form solid hydrates. A cementitious binder thus is curable with water and sets and hardens even under water. Examples for cementitious binders are cements, especially Portland cements according to standard EN 197-1, aluminate cement according to standard EN 14647, calcium sulfoaluminate cements. Cementitious binders of the present invention may additionally comprise pozzolanic and/or latent hydraulic materials. It is especially preferred within the present context for the cementitious binder to comprise or consist of cement and slag, especially Portland cement and ground granulated blast furnace slag (GGBFS). Further pozzolanic and/or latent hydraulic materials that may be present in the cementitious binder are fly ash, silica fume, micronized silica, trass, marl, and clay, especially calcined clay. According to embodiments, a method of the present invention is characterized in that the cementitious material comprises a cementitious binder, said cementitious binder comprising cement and slag, especially Portland cement and ground granulated blast furnace slag.

According to some embodiments, in a method of the present invention, the cementitious binder comprises or consists of Portland cement and slag, especially GGBFS, and the weight ratio of slag relative to the total dry weight of cementitious binder is at least 10 w %, preferably at least 20 w %, more preferably at least 40 w %, especially at least 66 w %.

The term “control of shrinkage” within the present context relates to a reduction of shrinkage and/or expansion of a cementitious composition as compared to a non-inventive composition without addition of aluminium powder and calcium oxide or magnesium oxide. Thus the terms “control” and “reduction” are used interchangeably herein. Shrinkage and/or expansion starts with the addition of water to a cementitious composition and continues during setting and hardening. Thus, within the present context, shrinkage includes plastic shrinkage as well as autogenous shrinkage and chemical shrinkage. However, shrinkage of fully hardened cementitious materials, for example due to carbonation, is not encompassed. Shrinkage and/or expansion can be measured according to standards EN 12617-4 (dimensional stability), ASTM C827 (fresh mortar expansion), and ASTM C1698 (autogenous shrinkage).

According to embodiments, in a method of the present invention aluminium powder, calcium oxide or magnesium oxide, and shrinkage reducing agent which is an organic molecule are added to a dry cementitious material. A dry cementitious material is a cementitious material as described above with a content of water of not more than 5 w %, preferably not more than 1 w %, relative to the total weight of the cementitious material. Such addition is especially possible during the production of dry mortars or dry grouts.

A method of the present invention may additionally comprise a step of adding water, especially mixing water to the cementitious composition. Water preferably is added in an amount sufficient to realize a desired workability of the resulting mix, Typically, water is added in an amount to realize a weight ratio of dry cementitious composition to water of between 0.05 and 1.0, preferably 0.06 and 0.3.

It is possible, in a method of the present invention, to add aluminium powder, calcium oxide or magnesium oxide, and a shrinkage reducing agent which is an organic molecule in one or more steps to the cementitious material.

It is, for example, possible to add all of aluminium powder, calcium oxide or magnesium oxide, and a shrinkage reducing agent which is an organic molecule in one step. One step addition is possible in the form of a pre-mix of aluminium powder, calcium oxide or magnesium oxide, and a shrinkage reducing agent which is an organic molecule.

It is, for example, possible to add aluminium powder, calcium oxide or magnesium oxide, and a shrinkage reducing agent which is an organic molecule in more than one step. For example, aluminium powder, calcium oxide or magnesium oxide, and a shrinkage reducing agent which is an organic molecule can be added one after the other in any given order to the cementitious composition.

According to embodiments, in a method of the present invention, aluminium powder, calcium oxide or magnesium oxide, and shrinkage reducing agent which is an organic molecule are added as a pre-mix or are added one after the other, in any given order, to a dry cementitious material.

According to embodiments, in a method of the present invention, aluminium powder, calcium oxide or magnesium oxide, and/or shrinkage reducing agent which is an organic molecule are added together with any mixing water.

The term “density” within the present context relates to the bulk density. Density within the present context is measured according to standard EN 1015-6.

It is known to the skilled person that the density of a cementitious material largely depends on the density of the constituents of the cementitious material and also on the air content of the hardened cementitious material.

To achieve a density of the cementitious material of not less than 800 kg/m³, preferably not less than 1800 kg/m³ after hardening, it is in particular preferred to limit the amount of any lightweight constituents and/or to limit the air content.

Lightweight constituents are aggregates or fillers with a low density, in particular a density of 1200 kg/m³ or lower. Lightweight constituents are for example, wood particles, rubber particles, plastic particles and/or porous particles such as foamed glass, expanded clay, or pumice. It is in particular preferred that a cementitious material of the present invention does not contain lightweight aggregates.

The air content of the hardened cementitious material should not exceed 14 Vol %, preferably not exceed 12 Vol %, especially should not exceed 6 Vol %. The air content can for example be lowered by the addition of suitable defoamers. One example of defoamer is tributyl phosphate. The air content can for example be lowered by the application of a reduced pressure on the cementitious material after mixing with water. Air content can for example be measured as described in standard EN 12350-7:2019.

Aluminium powder and calcium oxide or magnesium oxide within the present context are particulate materials. Particulate materials can be characterized by their particle size.

The particle size, its distribution or the average particle size of aluminium powder and of calcium oxide or magnesium oxide can be measured by laser diffraction, preferably according to standard ISO 13320:2009. In particular, an instrument Mastersizer 2000 with a dispersing unit Hydro 2000G and the software Mastersizer 2000 of the company Malvern Instruments GmbH (Germany) are used. Isopropanol, for example, is suitable as a measuring medium. Within the present context, the average particle size corresponds in particular to the D50 value (50% of the particles are smaller than the specified value, 50% are correspondingly larger).

According to embodiments, in a method of the present invention, the aluminium powder has a particle size D50 in the range of 0.1-45 μm, preferably 0.2-20 μm, more preferably 0.5-15 μm, still more preferably 1-10 μm, especially 2-8 μm.

According to embodiments, in a method of the present invention, the calcium oxide or magnesium oxide has a particle size D50 in the range of 10-50 μm.

Throughout the present invention calcium oxide and magnesium oxide can be used as alternatives.

A shrinkage reducing agent which is an organic molecule is added in a method of the present invention. According to embodiments, shrinkage reducing agents which are organic molecules are selected from glycols, preferably polypropylene glycols, polyethylene glycols, or mixed polypropylene-polyethylene glycols, alkyl ethers of polyalkylene glycols, especially neopentyl glycols, polyols, especially glycerin or erythritol, alkoxylated polyols, especially alkoxylated glycerin or alkoxylated erythritol, alkylated ethanolamine, carboxylic acid esters of polyalkylene glycols, especially fatty acid ester of polyalkylene glycols. A very preferable organic shrinkage reducing agent has the chemical structure (I)

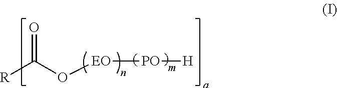

where
R independently from one another is a linear or branched, saturated or unsaturated aliphatic, cycloaliphatic or aromatic hydrocarbon moiety with 3 to 38 carbon atoms, EO is ethylene oxide, PO is propylene oxide,

$$\begin{matrix}a = 1 to 4 , \\ n = 0 - 40 , \\ m = 0 - 40 ,\end{matrix}$$

wherein the sum n+m=4-80,
and wherein EO and PO can be distributed randomly, block-wise or with a gradient.

According to embodiments, in a method of the present invention the aluminium powder is added in an amount of 0.0001-0.01 w % relative to the weight of cementitious binder present in the cementitious material.

A lower amount of aluminium powder is particularly suitable to achieve a density of the hardened cementitious material of not less than 800 kg/m³, preferably not less than 1800 kg/m³.

According to embodiments, the calcium oxide or magnesium oxide is added in an amount of 1-5 w % relative to the weight of cementitious binder present in the cementitious material.

According to embodiments, the shrinkage reducing agent which is an organic molecule is added in an amount of 0.1-2 w % relative to the weight of cementitious binder present in the cementitious material.

In another aspect, the present invention relates to a cementitious grout comprising or consisting of (in each case relative to the total dry weight of the cementitious grout)
a) 10-80 w % of a cementitious binder, said cementitious binder comprising cement and slag,
b) 0.0001-0.01 w % of aluminium powder,
c) 0.3-2 w % of calcium oxide or magnesium oxide,
d) 0.03-1 w % of a shrinkage reducing agent which is an organic molecule,
e) 10-80 w % relative to the dry weight of the grout of at least one aggregate and/or filler,
f) optionally 0.001-0.1 w % of azodicarbonamide, and
e) optionally further additives.

According to embodiments, a cementitious grout of the present invention comprises or consists of
a) 10-80 w %, relative to the cementitious grout, of a cementitious binder, said cementitious binder comprising cement and slag,
b) 0.0001-0.01 w %, relative to the cementitious binder, of aluminium powder,
c) 1-5 w %, relative to the cementitious binder, of calcium oxide or magnesium oxide,
d) 0.1-2 w %, relative to the cementitious binder, of a shrinkage reducing agent which is an organic molecule,
e) 10-80 w % relative to the dry weight of the grout of at least one aggregate and/or filler,
f) optionally 0.001-0.1 w % of azodicarbonamide, and
e) optionally further additives.

All embodiments described above also relate to this aspect.

Further additives are additives commonly known to be useful in cementitious compositions, especially concrete or mortar. Such additives especially are selected from accelerators, retarders, pigments, fibers, biocides, defoamers, air-entrainers, re-dispersible polymer powders, and viscosity modifiers, especially thickeners, plasticizers, and/or superplasticizers. Additives are different in chemistry and/or structure from the shrinkage reducing agent which are organic molecules as defined above.

One particularly useful further additive is azodicarbonamide. According to embodiments of the present invention, a method for the control of the shrinkage of cementitious materials comprises a step of adding azodicarbonamide to said cementitious material.

Aggregates and/or fillers are inert materials known from concrete or mortar industries. Aggregates especially are sand, gravel, recycled plastics, lightweight aggregate such as glass beads, and/or bio-sourced aggregates. Fillers especially are fine limestone powders.

According to embodiments, the cementitious binder in a cementitious grout of the present invention comprises or consists of 5-95 w % of Portland cement and 5-95 w % of slag, especially ground granulated blast furnace slag, in each case relative to the dry weight of the cementitious binder.

In some cases, it is preferable that the cementitious binder in a cementitious grout of the present invention of the present invention additionally comprises micro silica, silica fume, and/or calcium hydroxide.

Thus, a preferred cementitious binder may comprise or consist of
i) 5-50 w % of Portland cement,
ii) 5-50 w % of slag, especially ground granulated blast furnace slag,
iii) 1-5 w % of silica fume,
iv) 0.5-3 w % of micro silica, and
v) 0.1-1 w % of calcium hydroxide.

A very preferred cementitious grout of the present invention comprises or consists of
a) 10-80 w %, relative to the cementitious grout, of a cementitious binder, said cementitious binder consisting of
   i) 5-50 w % of Portland cement,
   ii) 5-50 w % of slag, especially ground granulated blast furnace slag,
   iii) 1-5 w % of silica fume,
   iv) 0.5-3 w % of micro silica, and
   v) 0.1-1 w % of calcium hydroxide,
b) 0.0001-0.01 w %, relative to the cementitious binder, of aluminium powder,
c) 1-5 w %, relative to the cementitious binder, of calcium oxide or magnesium oxide,
d) 0.1-2 w %, relative to the cementitious binder, of a shrinkage reducing agent which is an organic molecule,
e) 10-80 w % relative to the dry weight of the grout of at least one aggregate and/or filler,
f) optionally 0.001-0.1 w % of azodicarbonamide, and
e) optionally further additives.

Inventive grouts have a reduced or controlled shrinkage and/or expansion. Such grout materials can be used in applications where non-shrink grouts are required.

In another aspect the present invention relates to an admixture for cementitious compositions said admixture comprising aluminium powder, calcium oxide or magnesium oxide, and a shrinkage reducing agent which is an organic molecule. An admixture of the present invention may additionally comprise azodicarbonamide.

An admixture of the present invention can be used to control the shrinkage of cementitious materials.

All embodiments described above also relate to this aspect.

### EXAMPLES

### Example 1

Cementitious grout materials were prepared by thoroughly mixing the raw materials as indicated in below table 1 for 3 minutes on a laboratory mixer. Mixes were visually homogeneous. Examples 1 and 2 are comparative examples not according to the present invention. Examples 3 and 4 are inventive examples.

TABLE 1
compositions of examples (all numbers relate to w %)

| Example | 1 | 2 | 3 | 4 |
|---|---|---|---|---|
| CEM I 52.5 R | 24 | 24 | 24 | 24 |
| Slag*¹ | 10.5695 | 10.5695 | 10.5695 | 10.5695 |
| Silica fume*² | 3 | 3 | 3 | 3 |
| Micro silica*³ | 1.9 | 1.9 | 1.9 | 1.9 |
| Ca(OH)₂ | 0.13 | 0.13 | 0.13 | 0.13 |
| Sand*⁴ | 59 | 58.7 | 58.7 | 58.7 |
| Aluminium | 0.0005 | 0 | 0.0005 | 0.0005 |
| powder*⁵ | | | | |
| CaO*⁶ | 1 | 1 | 1 | 0 |
| MgO*⁷ | 0 | 0 | 0 | 1 |
| Organic SRA*⁸ | 0 | 0.3 | 0.3 | 0.3 |
| Additives*⁹ | 0.4 | 0.4 | 0.4 | 0.4 |

*¹ground granulated blast furnace slag (Blaine fineness 4′500 cm²/g)
*²BET surface 18-22 m²/g
*³particle size D50 100 μm
*⁴particle sizes 0.1-0.7 mm, 0.6-1 mm, 1-2 mm, 2-3 mm
*⁵particle size D50 8 μm
*⁶Lime CL-90 Q (<7% sieve residue at 90 μm)
*⁷particle size D50 15 μm
*⁸fatty acid ester of a mixed polyethylene/polypropylene glycol
*⁹mixture of defoamer, superplasticizer, thickener

For the preparation of liquid grouts, the respective powders of examples 1˜4 were slowly added to the mixing water within 3 minutes in a 3-L Hobart mixer. Water was used in an amount to give a water to powder weight ratio of 0.075. Mixing was then continued for 2 minutes at high speed. The liquid grout compositions were then immediately used for the following testing.

Dimensional stability was tested according to standard EN 12617-4. Fresh mortar expansion was measured according to standard ASTM C827. Autogenous shrinkage was measured according to standard ASTM C1698. All measurements were done after the time indicated in the below table 2.

The following table 2 gives an overview of the results.

TABLE 2
results measured

| Example | 1 | 2 | 3 | 4 |
|---|---|---|---|---|
| Dimensional stability | +1.15 | +0.9 | n.m. | +0.007 |
| (24 h) [mm/m] | | | | |
| Dimensional stability | −0.006 | −0.018 | n.m. | −0.006 |
| (7 d) [mm/m] | | | | |
| Fresh mortar expansion | +0.06 | −0.33 | 0 | n.m. |
| (1 h) [%] | | | | |
| Fresh mortar expansion | +0.6 | −0.53 | +0.6 | n.m. |
| (24 h) [%] | | | | |
| Autogenous shrinkage | −0.29 | −0.144 | −0.130 | n.m. |
| (1 d) [strain] | | | | |
| Autogenous shrinkage | −0.42 | −0.214 | −0.191 | n.m. |
| (4 d) [strain] | | | | |
| Bulk density | 2367 | 2375 | 2370 | 2369 |
| [kg/m³] | | | | |

n.m.: not measured
positive values indicate expansion, negative values indicate shrinkage

It can be seen from the above examples that inventive compositions show improved dimensional stability (cf examples 1 and 2 with example 4). It can also be seen that inventive compositions show good expansion in the fresh state and less autogenous shrinkage (cf examples 1 and 2 with example 3).

### Example 2

Cementitious grout materials were prepared in the same way as in example 1 by thoroughly mixing the raw materials as indicated in below table 3 for 3 minutes on a laboratory mixer. Mixes were visually homogeneous. Examples 5-8 are inventive examples.

TABLE 3
compositions of examples (all numbers relate to w %)

| Example | 5 | 6 | 7 | 8 |
|---|---|---|---|---|
| CEM I 52.5 R | 24 | 24 | 24 | 24 |
| Slag*¹ | 10.55 | 10.5695 | 10.5695 | 10.5698 |
| Silica fume*² | 3 | 3 | 3 | 3 |
| Micro silica*³ | 1.9 | 1.9 | 1.9 | 1.9 |
| Ca(OH)₂ | 0.13 | 0.13 | 0.13 | 0.13 |
| Sand*⁴ | 58.67 | 58.7 | 58.7 | 58.695 |
| Aluminium powder*⁵ | 0.05 | 0.0005 | 0.0005 | 0.0002 |
| CaO*⁶ | 1 | 1 | 1 | 1 |
| Organic SRA*⁸ | 0.3 | | | 0.3 |
| Organic SRA*¹⁰ | | 0.3 | | |
| Organic SRA*¹¹ | | | 0.3 | |
| Additives*⁹ | 0.4 | 0.4 | 0.4 | 0.4 |
| ADC*¹² | | | | 0.005 |

*¹ground granulated blast furnace slag (Blaine fineness 4′500 cm²/g)
*²BET surface 18-22 m²/g
*³particle size D50 100 μm
*⁴particle sizes 0.1-0.7 mm, 0.6-1 mm, 1-2 mm, 2-3 mm
*⁵particle size D50 8 μm
*⁶Lime CL-90 Q (<7% sieve residue at 90 μm)
*⁸fatty acid ester of a mixed polyethylene/polypropylene glycol
*⁹mixture of defoamer, superplasticizer, thickener
*¹⁰glycerine (99% purity)
*¹¹polyethylene glycol (Mw appr. 500 g/mol)
*¹²ADC: azodicarbonamide (CAS 123-77-3)

Liquid grouts were prepared in the same way as in example 1 with the respective powders of examples 5-8. Tests were done as described in example 1.

The following table 4 gives an overview of the results.

TABLE 4
results measured

| Example | 5 | 6 | 7 | 8 |
|---|---|---|---|---|
| Fresh mortar expansion | +11 | +0.23 | 0 | +0.2 |
| (1 h) [%] | | | | |
| Fresh mortar expansion | +11 | +0.6 | +0.67 | +0.87 |
| (24 h) [%] | | | | |
| Autogenous shrinkage | n.m. | −0.13 | −0.34 | −0.16 |
| (1 d) [strain] | | | | |
| Bulk density | 2386 | 2363 | 2368 | 2385 |
| [kg/m³] | | | | |

n.m.: not measured
positive values indicate expansion, negative values indicate shrinkage

1. A method for the control of the shrinkage of cementitious materials, the method comprising the steps of
(i) providing a cementitious material,
(ii) adding aluminium powder to the cementitious material,
(iii) adding calcium oxide or magnesium oxide to the cementitious material,
(iv) adding a shrinkage reducing agent which is an organic molecule to the cementitious material,
wherein the cementitious material has a density of not less than 800 kg/m³ after hardening.

2. A method as claimed in claim 1, wherein aluminium powder, calcium oxide or magnesium oxide, and shrinkage reducing agent which is an organic molecule are added to a dry cementitious material.

3. A method as claimed in claim 1, wherein aluminium powder, calcium oxide or magnesium oxide, and/or shrinkage reducing agent which is an organic molecule are added together with any mixing water.

4. A method as claimed in claim 1, wherein the cementitious material comprises a cementitious binder, the cementitious binder comprising cement and slag.

5. A method as claimed in claim 4, wherein the weight ratio of slag relative to the total dry weight of cementitious binder is at least 10 w %.

6. A method as claimed in claim 1, wherein the aluminium powder has a particle size D50 in the range of 0.1-45 μm.

7. A method as claimed in claim 1, wherein the calcium oxide or magnesium oxide has a particle size D50 in the range of 10-50 μm.

8. A method as claimed in claim 1, wherein the aluminium powder is added in an amount of 0.0001-0.01 w % relative to the weight of cementitious binder present in the cementitious material.

9. A method as claimed in claim 1, wherein the calcium oxide or magnesium oxide is added in an amount of 1-5 w % relative to the weight of cementitious binder present in the cementitious material.

10. A method as claimed in claim 1, wherein the shrinkage reducing agent which is an organic molecule is added in an amount of 0.1-2 w % relative to the weight of cementitious binder present in the cementitious material.

11. A method as claimed in claim 1, wherein the shrinkage reducing agent which is an organic molecule is selected from glycols, alkyl ethers of polyalkylene glycols, polyols, alkoxylated polyols, alkylated alkanolamines, and carboxylic acid esters of polyalkylene glycols.

12. A cementitious grout comprising or consisting of (in each case relative to the total dry weight of the cementitious grout)
a) 10-80 w % of a cementitious binder, the cementitious binder comprising cement and slag,
b) 0.0001-0.01 w % of aluminium powder,
c) 0.3-2 w % of calcium oxide or magnesium oxide,
d) 0.03-1 w % of a shrinkage reducing agent which is an organic molecule,
e) 10-80 w % relative to the dry weight of the grout of at least one aggregate and/or filler,
f) 0.001-0.1 w % of azodicarbonamide, and
g) further additives.

13. The cementitious grout according to claim 12, wherein the cementitious binder comprises or consists of 5-95 w % of Portland cement and 5-95 w % of slag in each case relative to the dry weight of the cementitious binder.

14. The cementitious grout according to claim 12, wherein the cementitious binder comprises or consists of (in each case relative to the dry weight of the cementitious binder)
i) 5-50 w % of Portland cement,
ii) 5-50 w % of slag,
iii) 1-5 w % of silica fume,
iv) 0.5-3 w % of micro silica, and
v) 0.1-1 w % of calcium hydroxide.

15. An admixture for cementitious compositions the admixture comprising aluminium powder, calcium oxide or magnesium oxide, and a shrinkage reducing agent which is an organic molecule.
